(19) United States
(12) Patent Application Publication
(10) Pub. No.: US 2024/0162712 A1
(43) Pub. Date: May 16, 2024

(54) Assigning Electrical Energy to a Group of Electrical Energy Stores

(71) Applicant: Bayerische Motoren Werke Aktiengesellschaft, Muenchen (DE)

(72) Inventors: Jens BERGER, Muenchen (DE); Alexander FUNKE, Baldham (DE)

(21) Appl. No.: 18/280,791

(22) PCT Filed: Feb. 28, 2022
(86) PCT No.: PCT/EP2022/054971

§ 371 Date: Sep. 7, 2023

(30) Foreign Application Priority Data
Mar. 8, 2021 (DE) 10 2021 105 460.5

(51) Int. Cl. H02J 3/32; B60L 53/14; B60L 53/63; B60L 55/00; B60L 58/12; H02J 3/00; H02J 7/00

(52) U.S. Cl. CPC H02J 3/322; B60L 53/14; B60L 53/63; B60L 55/00; B60L 58/12; H02J 3/003; H02J 7/00712; B60L 2260/54

(57) ABSTRACT

A method (S1-S9) is used to assign electrical energy (E) to a group of electrical energy stores (E1-En), in particular a fleet of electric vehicles (E1-En), several of which are intended for bidirectional conduction of current, wherein (a) at least one first instance (INST1), which controls individual load curves of the group of electrical energy stores, forecasts an aggregated load curve (PLG) for these energy stores (S1) and reports said aggregated load curve to a second instance (INST2-1, INST2-2) (S2), (b) the second instance trades an amount of energy corresponding to the forecast load curve (PLG) (S3), (c) the first instance, during the forecast period (T) that has then occurred, forecasts an aggregated load curve band (LGB) for the remaining duration of the forecast period in due consideration of the load curves actually implemented during the forecast period up until then (S4) and reports said aggregated load curve band to the second instance (S5), (d) the second instance determines an optimized load curve (LGO) from the reported load curve band (S6) and requests said optimized load curve from the first instance (S7) and (e) the first instance disaggregates the optimized load curve onto individual load curves for the energy stores controlled by said first instance and controls the energy stores on the basis of the associated individual load curves (S8).

### BACKGROUND AND SUMMARY OF THE INVENTION

The invention relates to a method for the assignment of electrical energy to a group of electrical energy stores, by charging and/or discharging. The invention further relates to a corresponding energy control system. The invention is applicable, in a particularly advantageous manner, to a group (fleet) of electric vehicles having an integrated and bidirectional charging technology.

From a press release issued by “The Mobility House”, it is known for electric vehicles having an integrated bidirectional charging technology to be integrated in the power grid, in the manner of power plants. To this end, a capability is employed, for the purposes of grid stabilization, for the injection of current from vehicle batteries into the electric power grid, which is also described as vehicle-to-grid (V2G) technology.

However, the prior art permits the incorporation of electric vehicles into a grid system in only a highly restricted and individual manner, and is not cost-effective.

The object of the present invention is to at least partially overcome the disadvantages of the prior art and, in particular, to provide an improved assignment and use of energy with respect to a group of energy stores, particularly of a fleet of electric vehicles, by way of bidirectional current conduction.

This object is fulfilled by the features of the claimed invention.

For example, this object is fulfilled by a method for assigning electrical energy to a group of electrical energy stores, wherein:
(a) at least one first instance, which controls individual load curves of the group of electrical energy stores, forecasts an aggregated load curve for these energy stores, and reports the latter to a second instance;
(b) for the forecast time period, the second instance trades a quantity of energy corresponding to the forecast load curve (i.e. by buying and/or selling or, or more generally, by the employment thereof for optimization, on an appropriate marketplace, optionally by way of an option only, etc.);
(c) the first instance, during the forecast period that has then occurred, forecasts an aggregated load curve band for the remaining duration of the forecast period, in due consideration of load curves actually implemented during the forecast period up to that point, and executes the reporting thereof to the second instance;
(d) the second instance determines an optimized aggregated load curve from the reported load curve band, and requests the latter from the first instance; and
(e) the first instance disaggregates the optimized load curve into individual load curves for the energy stores controlled by the former, and controls the energy stores, or charging processes thereof, on the basis of the associated individual load curves.

By the consolidation of load curves for the group of electrical energy stores, this method advantageously employs scaling effects for the improvement of the cost-effectiveness thereof, particularly wherein minimum quantities of tradeable electrical energy can be supplied, thus permitting a more efficient execution of energy distribution. In particular, previously forecast aggregated load curves or the associated forecast quantity of electrical energy, or the conduction thereof, during the forecast period can be updated on the basis of actual user behavior. The resulting energy difference can be re-traded by the second instance, in particular such that the actual quantity of energy taken up and distributed on the energy stores generates a price benefit.

The forecast period can correspond, for example, to a following day or a following week, particularly to the day which follows the day of notification of the aggregated load curve.

In a further development, control, or the facility for control of the individual load curves of the group of energy stores by the first instance comprises a facility for the control of a charging operation of the individual energy stores by the first instance. This comprises a facility for the charging, and for the discharging of energy stores by the first instance.

The “aggregated” load curve corresponds to a combination, particularly by addition, of the load curves of individual energy stores. It can also be considered that the load curves of individual energy stores are consolidated to form a “pool” or an “overall battery”.

A load curve, for example in the form of a characteristic or a table, can correspond to the requisite electrical energy or power demand associated with the forecast period, e.g. for the following day, in accordance with time windows in the forecast period, for example a quarter of an hour, an hour, etc. The load curve can thus correspond, for example, to a schedule of the respective energy or power demand for the 96 quarter-hour time windows of the following day. Energy or power demand can correspond to a foreseeable energy or power consumption of the energy stores and, optionally, to a quantity of energy or power which is retrievable from the energy stores.

Forecasting of the aggregated load curve for a subsequent forecast period can be derived, for example, from an at least approximately known charging behavior of energy stores, which is inferred from historical data, from user demand-side charging conditions, charging service agreements and further marginal conditions. Forecasting is known in principle, and thus will not be addressed in any further detail here.

The second instance can be, for example, an energy supplier, an energy trader, the first instance, etc.

For the forecast period (i.e. in advance of the forecast period), the second instance can undertake the time-dependent purchase of a quantity of energy which corresponds to the forecast aggregated load curve or energy characteristic, e.g. from an energy market, for example a spot market (e.g. EPEX or similar), or directly from another appropriate marketplace or participant in the energy market. Trading by the second instance of a corresponding quantity of energy for the forecast load curve of the forecast period can comprise a purchase and/or selling operation.

Forecasting by the first instance, during a forecast period which is then in progress, of an aggregated load curve band for the residual duration of the forecast period, and the notification thereof to the second instance, corresponds to an updating of the load curve for the forecast period, e.g. for the next day commencing, by reference to the actual charging behavior of the energy stores considered.

The term “load curve band” is understood as a load curve which assumes a certain bandwidth for each time window, and which can also be described as a “load curve with flexibility”. This bandwidth corresponds to the energy bandwidth which, in principle, is available to the second instance in the respective remaining duration of the time window. In the event that, for example, a specific energy store has not been employed, conversely to the original forecast, energy not consumed can thus be made available to the second instance, e.g. for sale during a period of high electricity prices, and for repurchase during a period of low electricity prices. This bandwidth can be determined by the first instance in a fundamentally known manner, e.g. by the application of an objective function. The load curve band can also be described as a load curve region.

Determination of an optimized aggregated load curve by the second instance from the load curve band thus notified, in particular, comprises the selection or determination by the second instance, in accordance with specific criteria, e.g. an achievable price optimization associated with trading on an appropriate energy market, for example the intraday market (EPEX), of a specific load curve from the load curve band available. This optimized load curve, or the difference from the originally forecast load curve, is requested of the first instance. This determination can also comprise actual trading (purchase or sale) of the relevant quantities of energy.

The first instance divides or disaggregates the optimized load curve into individual load curves for the energy stores which are controlled by the former and, correspondingly, controls charging processes for the energy stores on the basis of associated individual load curves.

According to one configuration, the group of electrical energy stores comprises a fleet of electric vehicles, a number of which are configured for bidirectional current conduction. At least a number of electric vehicles can thus be V2G-capable, by interaction with their charging stations.

Thereafter, forecasting of the aggregated load curve for a subsequent forecast period can also take account of known mobility requirements of users of electric vehicles.

Electric vehicles can be e.g. plug-in hybrid electric vehicles (PHEV), fuel cell hybrid vehicles (FCHV) or battery electric vehicles (BEV). Correspondingly, energy stores can be e.g. electrochemical energy stores such as batteries, or fuel cells, etc. Hereinafter, terms for electric vehicles and the electrical energy stores contained therein can also be employed synonymously, unless any indication to the contrary proceeds from the context.

In this configuration, in particular, the first instance can be a manufacturer of electric vehicles or a fleet operator.

Alternatively or additionally, the group of electrical energy stores can comprise further rechargeable electrical energy stores, e.g. stationary electrical energy stores.

According to one configuration, updating by way of steps (c) to (e) can be executed repeatedly for each time window of a forecast period in progress. An optimization of the quantity of energy can thus be executed in a particularly efficient and continuous manner.

According to one configuration:
in step (a), the first instance forecasts an aggregated load curve band for these energy stores and notifies the latter to a second instance, and
in step (b), from the load curve band forecast in step (a), the second instance determines an optimized aggregated load curve, trades a corresponding quantity of energy, and reports the optimized aggregated load curve to the first instance.

An advantage is thus achieved in that, in an analogous manner to steps (c) and (d), from the original forecasts, an optimized load curve can be determined or established by the second instance, by reference to specific criteria, such as fluctuating energy prices during the forecast period.

According to one configuration, the group of energy stores comprises a fleet of electric vehicles, a number of which, in particular, are configured for bidirectional current conduction, wherein, in step (e), the first instance then disaggregates the optimized load curve into individual load curves for the energy stores which are controlled by the latter, such that mobility requirements of the individual electric vehicles are not compromised. An advantage is thus achieved, in that load curves can be optimized without restricting the mobility of vehicle users. For example, it can thus be considered that, during the discharging of an energy store, a predefined, e.g. contractually stipulated minimum state-of-charge of the vehicle must not be undershot, or that recharging of energy store is executed up to a presumed time of use. If, for example, it is known from historical data that, on working days, a specific electric vehicle is only driven between 8:00 a.m. and 9:00 a.m., and then again between 5:00 p.m. and 6:00 p.m., the first instance, between these time periods, can discharge the energy store while electricity prices are high, and execute recharging while electricity prices are low, wherein it is considered, in particular, that a minimum state-of-charge must not be undershot at any time.

According to one configuration, in step (d), the optimized aggregated load curve is only requested of the first instance if the associated quantity of energy achieves or exceeds a predefined minimum quantity of energy. It is thus achieved that, in step (d), a particularly efficient optimization of the quantity of energy is executed, as such optimization only proceeds in the event that tradeable minimum quantity of energy has also been achieved.

According to one configuration, the second instance comprises two separate instances, namely, a first second instance (“marketer or aggregator instance”) and a second second instance (“energy supplier”). In principle, steps of the method which are executed by the second instance can arbitrarily be executed by the aggregator instance and/or by the energy supplier. For example, the aggregator instance can be a brokering, marketing or trading instance. In particular, the aggregator instance is set-up or organized for the aggregation of, and subsequent trading with an entire portfolio of customers, i.e. not only the above-mentioned first instance.

For example, the first instance, in step (a), can report the aggregated load curve to the energy supplier, who trades the corresponding quantity of energy in step (b) whereas, in step (c), the first instance reports to the aggregator instance which, in step (d), determines an optimized aggregated load curve, including the trading of associated quantities of energy on the energy market. Quantities of energy thus traded can then be relayed to the energy supplier. Alternatively, the aggregator instance calculates the optimized aggregated load curve as an option only, and reports the latter to the energy supplier, who then trades (i.e. purchases and/or sells) a quantity of energy on the energy market, in accordance with the optimized aggregated load curve.

Alternatively, the second instance can also comprise only the aggregator instance or the energy supplier.

Thus, in general, according to one configuration, the second instance comprises an aggregator instance and/or an energy supplier.

The request for the quantity of energy determined in accordance with the optimized aggregated load curve in step (d) can also be requested from the first instance by the aggregator instance or by the energy supplier.

In particular, the delivery and take-up of quantities of energy from the energy supplier at the grid connection point for the supply of electrical energy stores (particularly of electric vehicles or the charging stations thereof) and, optionally, of further loads, can be logged by way of networked intelligent metering systems (or “smart meters”).

The object of the invention is also fulfilled by an energy control system comprising at least one first instance, which is configured to execute steps (a), (c) and (e) of the above-mentioned method. The energy control system can be configured in an analogous manner to the method, and provides the same advantages.

The object of the invention is also fulfilled by a system which is designed to execute the above-mentioned method.

The above-mentioned properties, features and advantages of the present invention, and the manner in which these are achieved, will be further illustrated and clarified with reference to the following schematic description of one exemplary embodiment, which is described in greater detail with reference to the drawings.

### BRIEF DESCRIPTION OF THE DRAWINGS

FIG. 1 shows a sketch of an energy distribution system for the assignment of electrical energy to a fleet of electric vehicles.

FIG. 2 shows a potential sequence for the assignment of electrical energy to a fleet of electric vehicles.

FIG. 3 shows a sketch of a forecast aggregated load curve.

FIG. 4 shows a sketch of a load curve band.

FIG. 5 shows an alternative potential sequence for the assignment of electrical energy to a fleet of electric vehicles.

### DETAILED DESCRIPTION OF THE DRAWINGS

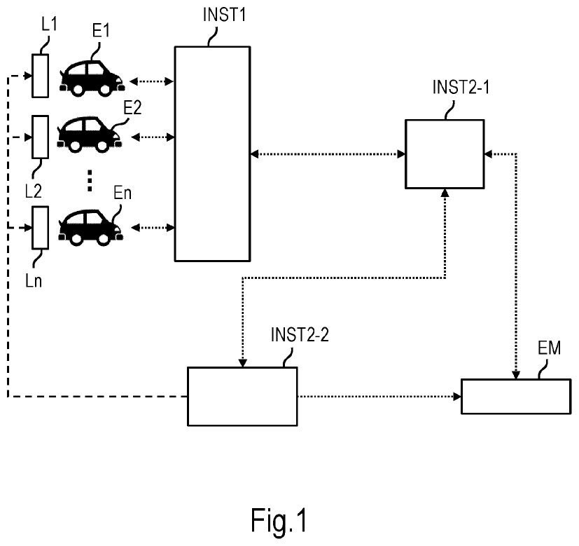

FIG. 1 shows a sketch of an energy distribution system for assigning electrical energy to a fleet of electric vehicles E1, E2, . . . , En. The electric vehicles E1 to En are connectable to charging stations L1, L2, Ln, and are then configured for bidirectional current conduction, e.g. in accordance with V2G technology.

Individual load curves, including the charging and discharging of electric vehicles E1 to En, are controllable by way of a first instance INST1 which, in this case, for example, corresponds to the manufacturer of electric vehicles E1 to En. The first instance INST1 is configured, e.g. on the basis of previous user behavior and other marginal conditions, to forecast an aggregated, or consolidated, or “pooled” load curve for these electric vehicles E1 to En.

The first instance INST1 is connected, with a data transmission capability, to an aggregator instance INST2-1, which is configured to trade quantities of electrical energy on an energy market EM, for example a spot market, particularly by way of the purchase and sale of quantities of energy at specific times. According to a further development, purchases and sales can be actuated only with effect from a specified minimum quantity. In particular, the aggregator instance INST2-1 corresponds to an energy broker or trader.

In general, the achievement of minimum quantities is more straightforward, the greater the number of electric vehicles E1 to En, the load curves of which are controlled by the first instance. For example, the number n can be in the region of hundreds, thousands, tens of thousands, hundreds of thousands or even more electric vehicles E1 to En.

The first instance INST1 is further coupled, with a data transmission capability, to an energy supplier INST2-2, which delivers electrical energy from a power grid to the charging stations L1 to Ln, and from thence to the electric vehicles E1 to En for the charging thereof, and which can inject energy tapped from the electric vehicles E1 to En into the electric power grid. Actual energy flux quantities (current or power) are logged by the energy supplier INST2-2, or by a metering point operator who is appointed by the latter (not represented). The energy supplier INST2-2, in particular, is a market participant, who can and is permitted to supply energy to final customers.

The energy supplier INST2-2 is moreover coupled to the aggregator instance INST2-1, with a data transmission capability and, optionally, can also be coupled to the energy market EM, with a data transmission capability.

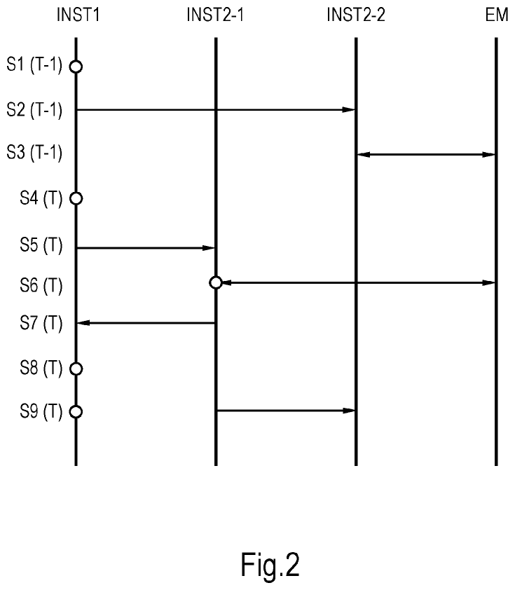

FIG. 2 shows a potential sequence for the assignment of electrical energy to the fleet of electric vehicles E1 to En.

In a step S1, on a previous day T-1, an aggregated load curve of electric vehicles for the next day T is forecast by the first instance INST1 on the basis of probable individual charging processes and, in a step S2, still on the previous day T-1, is reported to the energy supplier INST2-2.

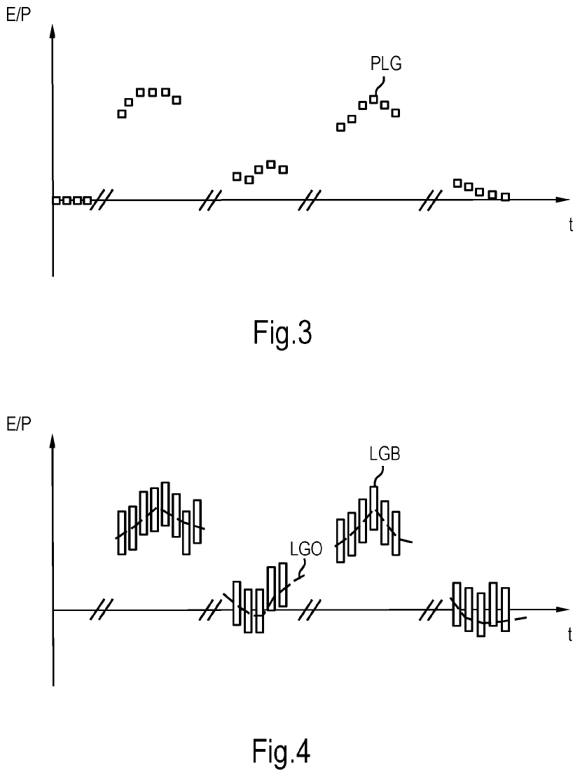

FIG. 3 shows a sketch of a forecast aggregated load curve PLG of this type, in the form of a quantity of energy E or power P plotted against time on the following day in quarter-hour time windows. In consequence, 96 time windows are present, to each of which a forecast aggregated quantity of energy is assigned. In the present case, this quantity of energy corresponds to the forecast aggregated probable energy consumption at the charging stations L1 to Ln. As illustrated, for example, at the start of the day T, energy consumption is initially close to zero, then increases as users travel to work or to the shops, remains at a medium level in the middle of the day, rises in the evening as users return home, then declines again over the course of the evening.

Alternatively, in place of energy consumption, an energy characteristic can be notified, which also comprises a quantity of energy which is available for take-up by the electric vehicles E1 to En at the charging stations L1 to Ln (not represented). In this case, quantities of energy can also be negative.

Returning to FIG. 2, still on the previous day T-1, the energy supplier INST2-2 purchases a time-distributed quantity of energy for the next day T from the energy market EM which corresponds to the load curve thus notified.

Alternatively, the energy supplier INST2-2 can also sell energy E or power P which is available in the batteries of the electric vehicles E1 to En, to the energy market EM, in the event of a probable non-consumption, provided that the mobility of the electric vehicles E1 to En is not restricted. If, for example, electric power is more expensive between 12 midnight and 2:00 a.m. than between 2:00 a.m. and 4:00 a.m., the energy supplier INST2-2 can sell a specific quantity of energy which is stored in the batteries of the electric vehicles E1 to En between 12 midnight and 2:00 a.m., such that the electric vehicles E1 to En are correspondingly discharged, then execute recharging between 2:00 a.m. and 4:00 a.m., as a result of which a financial advantage can be generated in its favor, with no resulting negative impacts upon the mobility requirements of vehicle operators.

On the next day T, corresponding to the forecast period, in a step S4, for each quarter of an hour completed, the first instance INST1 then forecasts an updated aggregated load curve band LGB for the residual duration of the day T, by refence to the actual charging behavior or charging processes actually executed for the electric vehicles E1 to En. The load curve band LGB thus no longer comprises only one value per time window, but an energy band calculated by the first instance INST1 by reference to an objective function, which comprises a minimum and maximum quantity of energy which is available to trade in the associated time window. FIG. 4 shows a sketch of a load curve band LGB of this type.

Returning to FIG. 2, in a step S5, the first instances INST1 reports or transmits the load curve band LGB to the aggregator instance INST2-1.

The aggregator instance INST2-1, in a step S6, from the load curve band LGB, by way of adjustment to the energy market EM (e.g. by way of price comparisons in a quarter-hour intraday market), retrieves or determines a specific load curve LGO, represented in FIG. 4 by a broken line, which is optimized with respect to specific criteria, e.g. low power prices. In the present variants of the method, the aggregator instance INST2-1, in conjunction with the determination of the optimized load curve LGO, executes a corresponding trade with the energy market EM.

In a step S7, the aggregator instance INST2-1 requests an optimized load curve LGO from the first instance INST1, i.e. the reporting thereto of the optimized load curve LGO by the first instance, and anticipates that the first instance INST1 will control the load curves of the electric vehicles E1 to En such that actual quantities of energy exchanged, i.e. the take-up or output thereof by the electric vehicles E1 to En, particularly via the energy supplier INST2-2, correspond to the optimized load curve LGO.

In a step S8, the first instance INST1 divides or “disaggregates” the optimized load curve LGO into individual load curves for the electric vehicles E1 to En which are controlled by the latter, and controls the individual load curves for the electric vehicles E1 to En accordingly.

In an optional step S9, the aggregator instance INST2-1 can additionally report the optimized load curve LGO, or a difference from the most recent valid aggregated load curve, to the energy supplier INST2-2, as a result of which a balancing group settlement can be achieved. This step is particularly necessary if INST2 is comprised of two different market operators.

Steps S3 to S9, as indicated above with reference to step S4, can be repeated for each time window of the current day T.

It is not necessary for all the above-mentioned steps to be executed in the sequence described. Thus, for example, steps S7 and S9 can also be executed in reverse order, or can be executed simultaneously.

The above-mentioned instances INST1, INST2-1, INST2-2 can be different instances, e.g. economically and/or organizationally separate instances. Alternatively, at least two of the instances INST1, INST2-1, INST2-2 can be consolidated in a single instance, e.g. the agreggator instance INST2-1 and the energy supplier INST2-2 can form a single second instance. Additionally, for example, the first instance INST1 can comprise an aggregator instance INST2-1, e.g. can represent itself as an energy dealer or broker.

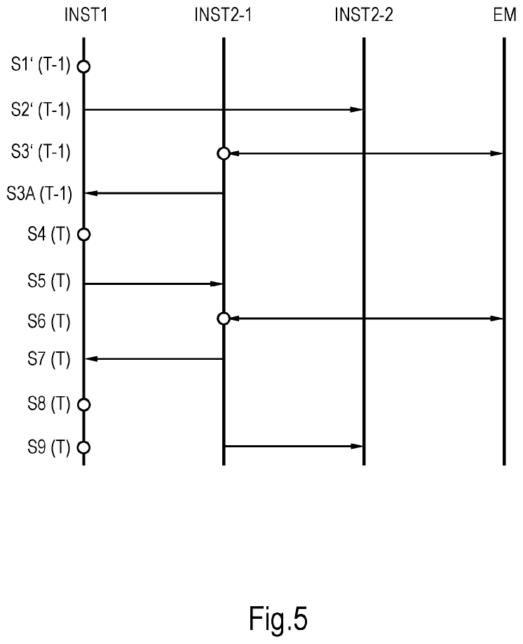

FIG. 5 shows an alternative potential sequence for the assignment of electrical energy to the fleet of electric vehicles E1 to En.

This method employs the same steps for the current day S4 to S8 or S9 as per the method described according to FIG. 2, but differs with respect to the determination of the load curve on the preceding day. In the present case, this is determined in a similar manner to the optimized load curve LGO in the method described according to FIG. 2.

To this end, in a step S1′, the first instance INST1, on the previous day T-1, determines a load curve band, which is determined e.g. in an analogous manner to the load curve band LGB and, in a step S2′, executes the reporting thereof to the aggregator instance INST2-1.

In step S3′, the aggregator instance INST2-1, in an analogous manner to step 6, by way of adjustment to the energy market EM, selects an optimized load curve from this load curve band and, in a step S3A, executes the feedback thereof to the first instance INST1. According to one variant, it is possible for the aggregator instance INST2-1 to already have traded the corresponding quantities of energy on the energy market EM. Additionally, it can report the optimized load curve to the energy supplier. Alternatively, the aggregator instance INST2-1 reports the optimized load curve to the energy supplier INST2-2, which can execute the corresponding trade.

Naturally, the present invention is not limited to the exemplary embodiment illustrated.

In general, the terms “a”, “an”, etc. can be understood to signify a singular or a plural, particularly in the sense of “at least one”, “one or more”, etc., provided that this is not explicitly excluded, e.g. by the expression “exactly one”, etc.

Indication of number can also comprise the exact number indicated, or can incorporate a customary margin of tolerance, provided that this is not explicitly excluded.

### LIST OF REFERENCE SYMBOLS

CLEAN COPY
E Electrical energy
EM Energy market
E1-En Electric vehicle
INST1 First instance
INST2-1 Aggregator instance
INST2-2 Energy supplier
LGB Load curve band
LGO Optimized load curve
L1-Ln Charging station
P Electric power
PLG Forecast aggregated load curve
S1-S9 Process steps
S1′-S3′ Process steps
S3A Process step
T Day
t Time

1.-8. (canceled)

9. A method for assigning electrical energy to a group of electrical energy stores, the method comprising the steps of:
(a) forecasting, by a first instance, which controls individual load curves of the group of electrical energy stores, an aggregated load curve for the energy stores, and reporting, by the first instance, the forecast aggregated load curve to a second instance;
(b) for a forecast time period, trading, by the second instance, a quantity of energy corresponding to the forecast aggregated load curve;
(c) during the forecast period forecasting, by the first instance, an aggregated load curve band for a remaining duration of the forecast period, in due consideration of load curves actually implemented for the energy stores aggregated during the forecast period up to that point, and executing, by the first instance, reporting of the load curve band to the second instance;
(d) determining, by the second instance, an optimized aggregated load curve from the reported aggregated load curve band, and requesting, by the second instance, the optimized aggregated curve from the first instance; and
(e) disaggregating, by the first instance, the optimized aggregated load curve into individual load curves for the energy stores controlled by the first instance, and controlling, by the first instance, the energy stores based on the associated individual load curves.

10. The method according to claim 9, wherein the group of electrical energy stores comprises a fleet of electric vehicles, a number of which are configured for bidirectional current conduction.

11. The method according to claim 9, wherein steps (c) to (e) are executed repeatedly for each time window of the forecast period in progress.

12. The method according to claim 9, wherein:
in step (a), the first instance forecasts an aggregated load curve band for the energy stores and notifies the aggregated load curve band to the second instance, and
in step (b), from the aggregated load curve band forecast in step (a), the second instance determines an optimized aggregated load curve, trades a corresponding quantity of energy, and reports the optimized aggregated load curve to the first instance.

13. The method according to claim 10, wherein, in step (e), the first instance disaggregates the optimized aggregated load curve into individual load curves for the electric vehicles such that mobility requirements of the electric vehicles are not compromised.

14. The method according to claim 9, wherein in step (d), the optimized aggregated load curve is only requested of the first instance upon determining that an associated quantity of energy achieves or exceeds a predefined minimum quantity of energy.

15. The method according to claim 9, wherein the second instance comprises at least one of an aggregator instance or an energy supplier.

16. An energy control system comprising the first instance which is configured to execute steps (a), (c) and (e) of the method according to claim 9.
